(19) United States
(12) Patent Application Publication
(10) Pub. No.: US 2014/0106684 A1
(43) Pub. Date: Apr. 17, 2014

(54) TRANSPARENT ANTENNAS ON A DISPLAY DEVICE

(71) Applicant: QUALCOMM MEMS TECHNOLOGIES, INC., San Diego, CA (US)

(72) Inventors: David William Burns, San Jose, CA (US); Jonathan Charles Griffiths, Fremont, CA (US)

(73) Assignee: QUALCOMM MEMS TECHNOLOGIES, INC., San Diego, CA (US)

(21) Appl. No.: 13/652,344

(22) Filed: Oct. 15, 2012

(51) Int. Cl. H01Q 1/24; H01P 11/00; H04B 1/44; G06F 15/00; G06F 3/01

(52) U.S. Cl. 455/78; 345/501; 345/156; 343/702; 29/601

(57) ABSTRACT

This disclosure provides systems, methods and apparatus for a display device with at least one transparent antenna. In one aspect, a transparent antenna is formed on the surface of a transparent substrate and is cooperatively coupled with a second antenna. The transparent antenna can avoid substantial interference with images produced by the display device.

### TECHNICAL FIELD

This disclosure relates generally to antennas and more particularly to transparent antennas on a display device, such as an electromechanical systems (EMS) display device.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Many mobile display devices such as cellular phones, smart phones, e-readers, and tablet computers have increasingly limited space to place antennas for wireless communications, while demands for higher data rates and operation over multiple bands and protocols have increased. To avoid interfering with images formed on a display device, antennas are conventionally buried inside or attached to a sidewall of an enclosure, or may protrude from a body of the display device. In part because mobile display devices are increasingly required to accommodate features such as GPS, Wi-Fi, and NFC in addition to one or more cellular bands along with higher data transfer rates, alternative antenna configurations and placements are being explored.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display device. The display device can include a transparent substrate through which an image can be displayed, where the transparent substrate includes a surface having a display region and a non-display region that surrounds at least a portion of a perimeter of the display region. The display device also can include a first antenna formed in the display region of the transparent substrate, where the first antenna is substantially transparent, and a second antenna cooperatively coupled with the first antenna.

In some implementations, the first and the second antennas are spatially diverse. In some implementations, the second antenna is formed on the same surface of the transparent substrate as the first antenna. In some implementations, the display device further includes one or more electrically conductive traces formed on the first antenna, where the electrically conductive traces are configured to electrically reinforce the first antenna. In some implementations, the display device further includes a printed circuit board in electrical communication with the first antenna, where the second antenna is physically connected to the printed circuit board. The first antenna may be configured for receiving wireless signals and the second antenna may be configured for transmitting wireless signals. In some implementations, the second antenna is substantially non-transparent. In some implementations, the first antenna and the second antenna form part of a multiple-input multiple-output (MIMO) antenna configuration. In some implementations, the first antenna includes a transparent conductive oxide.

Another innovative aspect of the subject matter described in this disclosure can be implemented in a display device. The display device can include means for displaying an image, means for receiving a wireless signal disposed on a surface of the displaying means, and means for transmitting a wireless signal cooperatively coupled to the receiving means. The receiving means is substantially transparent.

In some implementations, the display device further includes a printed circuit board in electrical communication with the transmitting means, where the transmitting means is physically connected to the printed circuit board. In some implementations, the display device further includes means for switching, where the switching means is configured to selectively switch between the transmitting means and the receiving means.

Another innovative aspect of the subject matter described in this disclosure can be implemented in a method of manufacturing a display device. The method can include providing a transparent substrate through which an image can be displayed, where the transparent substrate includes a surface having a display region and a non-display region that surrounds at least a portion of a perimeter of the display region. The method also can include forming a first antenna in the display region of the transparent substrate, and coupling cooperatively a second antenna with the first antenna. The first antenna is substantially transparent and the second antenna is substantially non-transparent.

In some implementations, the method further includes providing a printed circuit board in electrical communication with the first antenna, where the second antenna is physically connected to the printed circuit board, and providing a display element between the printed circuit board and the first transparent antenna. In some implementations, the first and the second antennas have at least one of spatial diversity, temporal diversity, frequency diversity, and polarization diversity with each other.

Another innovative aspect of the subject matter described in this disclosure can be implemented in a method of operating a display device. The method can include detecting a head of a user. The method also can include switching from a display-side antenna disposed on an exterior surface of the display device to an enclosure antenna disposed on an interior surface of the display device when the detected head is proximate the display-side antenna. The method also can include transmitting a wireless signal from the enclosure antenna.

In some implementations, detecting the head of the user can include detecting with a proximity sensor. In some implementations, the exterior surface includes a display region and a non-display region that surrounds a perimeter of the display region, where the display-side antenna includes one or more transparent antennas in the display region. In some implementations, the exterior surface includes a display region and a non-display region that surrounds at least a portion of a perimeter of the display region, where the display-side antenna includes one or more non-transparent antennas in the non-display region.

Another innovative aspect of the subject matter described in this disclosure can be implemented in a machine-readable, non-transitory storage medium comprising computer executable instructions for operating a display device. The instructions can include detecting a head of a user, switching from a display-side antenna disposed on an exterior surface of the display device to an enclosure antenna disposed on an interior surface of the display device when the detected head is proximate the display-side antenna, and transmitting a wireless signal from the enclosure antenna.

In some implementations, the computer executable instructions are configured to control one or more processors, where the one or more processors are operatively coupled to a proximity sensor configured to detect the head of the user.

Details of one or more implementations of the subject matter described in this disclosure are set forth in the accompanying drawings and the description below. Although the examples provided in this disclosure are primarily described in terms of EMS and MEMS-based displays, the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an example of a graph illustrating channel capacity as a function of the number of antennas.

FIG. 2A is an example of a cross-sectional side view schematic illustration of an antenna in front of a display of a display device.

FIG. 2B is an example of a topside view of a transparent substrate having a display region and a non-display region.

FIG. 2C is an example of a cross-sectional side view schematic illustration of an antenna panel behind a display of a display device.

FIG. 3A is an example of a perspective view of a transparent antenna on a transparent substrate.

FIG. 3B is an example of a perspective view of a transparent antenna with electrically conductive traces on a transparent substrate.

FIG. 3C is an example of a perspective view of multiple antennas on a transparent substrate.

FIG. 3D is an example of a perspective view of a transparent antenna in a display region of a transparent substrate and one or more antennas in a non-display region of the transparent substrate.

FIG. 3E is an example of a perspective view of multiple antennas in a non-display region of a transparent substrate.

FIG. 3F is an example of a detailed view of a grid that forms a portion of a substantially transparent antenna.

FIG. 3G is an example of a detailed view of an electrically reinforcing grid on a substantially transparent antenna.

FIG. 3H is an example of a detailed view of a curvilinear reinforcing grid on a substantially transparent antenna.

FIG. 4 is an example of a cross-sectional side view schematic illustration of a first antenna on a transparent substrate and a second antenna on a printed circuit board.

FIG. 5 is an example of a diagram illustrating an operating mode of a multi-antenna system.

FIG. 6 is an example of a flow diagram illustrating a method of manufacturing a display device.

FIG. 7 is an example of a flow diagram illustrating a method of operating a mobile display device.

FIG. 8 is an example of a cross-sectional side view illustrating a process sequence for fabricating a transparent antenna.

FIG. 9 is an example of a cross-sectional side view illustrating a process sequence for fabricating a transparent antenna with a substantially transparent grid.

FIG. 10 is an example of a cross-sectional side view illustrating a process sequence for fabricating a transparent antenna with electrically reinforcing traces on a substantially transparent antenna.

FIG. 11 is an example of a cross-sectional side view illustrating a process sequence for fabricating a transparent antenna with a substantially transparent grid of a black interferometric stack structure.

FIG. 12 is an example of a cross-sectional side view illustrating a process sequence for fabricating a transparent antenna with electrically reinforcing traces of a black interferometric stack structure on a substantially transparent antenna.

FIG. 13 is an isometric view illustration depicting two adjacent interferometric modulator (IMOD) display elements in a series or array of display elements of an IMOD display device.

FIG. 14 is a system block diagram illustrating an electronic device incorporating an IMOD-based display including a three-element by three-element array of IMOD display elements.

FIGS. 15A and 15B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Some implementations described herein relate to display devices with one or more antennas on a transparent substrate through which a display may be viewed. The one or more antennas on the transparent substrate may be substantially transparent to allow suitable viewing of an underlying display. In some implementations, narrow electrically conductive traces may serve as the antenna or the electrically conductive traces may augment the performance of an antenna formed from a transparent conductive film. The electrically conductive traces may augment the performance of the antenna by electrically reinforcing it. In some implementations, the antenna may be transparent and cooperatively coupled with a second antenna that may or may not be transparent. The antenna may cooperatively couple with the second antenna by having both antennas used together in a single system, under control of a single system, used interchangeably, or used independently or together within a single system. In some implementations, the second antenna may lie in a non-display region of the transparent substrate. In some implementations, the second antenna may be positioned within an enclosure of the display device, such as on a printed circuit board or on a sidewall or interior surface of the enclosure. In some implementations, multiple antennas on the transparent substrate may provide access to one or more cellular or non-cellular wireless bands. In some implementations, multiple antennas may be configured in front of or behind the display to provide enhanced data transfer rates through adaptive antenna arrays, beam forming, or multiple-input multiple-output based (MIMO-based) wireless communications.

Particular implementations of the subject matter described in this disclosure may be implemented to realize one or more of the following potential advantages. The use of a transparent antenna increases the regions for suitable placement of an antenna in a display device, by allowing placement in regions where an image may be displayed. Multiple antennas may be formed on a display device or positioned in an enclosure of the display device so that the wireless communication system may benefit from antenna diversity, such as, for example, spatial, frequency, temporal, or polarization diversity, etc. Antenna diversity is the use of two or more antennas to improve the quality and reliability of a wireless signal. While a transparent antenna alone may have less than desirable antenna gain resulting from the relatively low electrical conductivity of most transparent conductive materials, in some implementations a transparent antenna augmented or electrically reinforced with narrow, electrically conductive traces may improve the overall antenna efficiency. A transparent antenna cooperatively coupled with one or more antennas on the display or within the enclosure of the display device may provide increased channel capacity for higher data rates and/or improved system performance with increased spatial, frequency, temporal, or polarization diversity. For example, a transparent antenna cooperatively coupled with a second antenna may increase the frequency bands over which the display device operates.

A transparent antenna cooperatively coupled with a second antenna may provide multiple operating modes by allowing the selective switching between antennas. In some implementations, a display-side antenna and an enclosure antenna may be selectively switched to receive the signal with the highest signal level. In some implementations, a display-side antenna may be used to receive low-level signals and an enclosure antenna may be used to transmit high-level signals. In some implementations, an enclosure antenna may be used for transmission when a user's face or head is detected near a display-side antenna. In some implementations, two, three, four or more antennas may be positioned on the display side of the display device, optionally cooperatively coupled with one or more antennas within the enclosure of the display device and switched accordingly to achieve increased uplink and downlink data rates using MIMO (multiple-input, multiple-out) configurations, beam-forming, or adaptive antenna arrays.

In some implementations, a transparent antenna electrically reinforced with electrically conductive traces or cooperatively coupled with a transparent or non-transparent antenna may be formed on or over a display device, such as, for example, an EMS or MEMS display device, or other type of display device such as an LCD, OLED, or electrophoretic display. An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

In recent years, wireless communications have become more widespread in display devices, including EMS and MEMS display devices. Specialized antennas are incorporated in mobile display devices to respond to increasing demands in wireless communications. However, with the performance of display devices becoming higher and the size of some display devices becoming smaller, the space for allocating antennas is becoming increasingly limited.

Furthermore, an increasingly larger group of communication frequencies has proliferated, including non-cellular wireless standards such as global positioning systems (GPS), Bluetooth protocols, wireless local area networks (WLAN), Wi-Fi networks, worldwide interoperability for microwave access (WiMax) networks, radio frequency identification (RFID), near field communications (NFC), high-definition television (HDTV), frequency modulation (FM) broadcast radio, multiple-input multiple-output (MIMO) systems, and ultra-wide band (UWB) protocols. Some of the frequency bands related to these standards and others are going to higher frequencies, such as 2-5 GHz, 5-10 GHz and higher, such as in the 60 GHz range.

In addition, demand for higher data rates has grown. With larger amounts of data being transmitted wirelessly, display devices are being adapted for increased channel capacity for reliably transmitting data over one or more communication channels. However, the channel capacity of a display device may be limited by the type, quality, size, placement, and quantity of the associated antennas.

Transparent antennas positioned on or over a display may provide greater amounts of space to allocate one or more antennas. However, many transparent antennas, such as those made of indium-tin-oxide (ITO), have relatively low electrical conductivity that can result in low antenna efficiency. While transparent antennas based on an electrically conductive oxide alone may not be able to meet the increasing demands for more frequency bands and higher data rates, the transparent antennas may be cooperatively coupled with another transparent or non-transparent antenna or otherwise augmented to improve antenna and overall system performance. Cooperatively coupling an antenna with another antenna as used herein may define using the antennas together in a single system or as part of a single device, using the antennas under the control of a single system, using the antennas interchangeably under a single system, or operating the antennas independently or together in a single system. Augmenting an antenna as used herein may define electrically reinforcing the antenna to improve antenna performance.

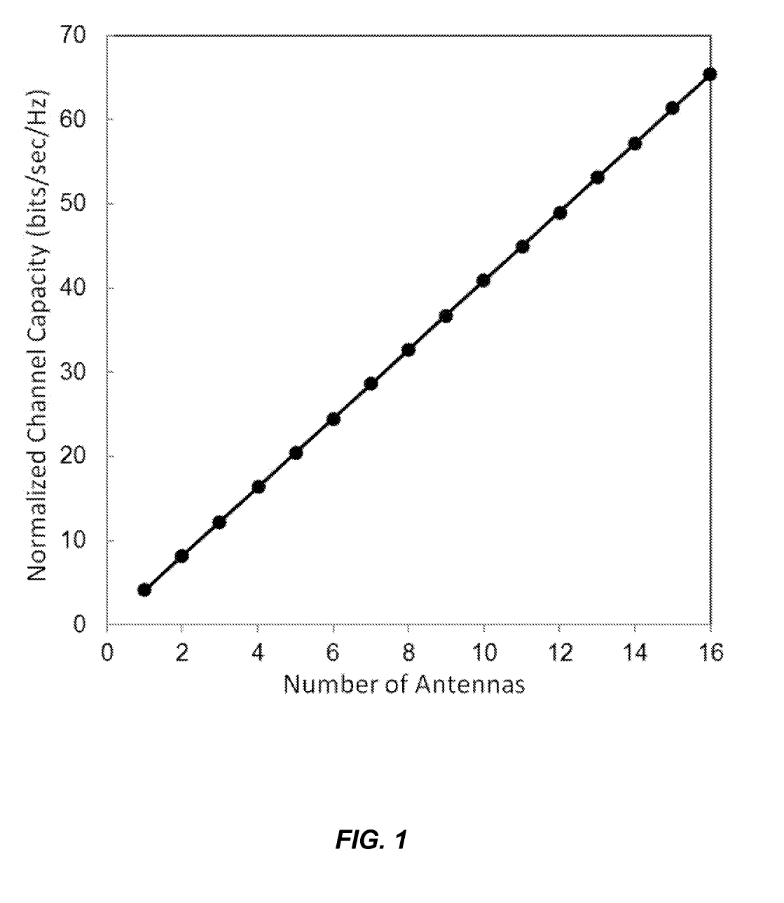

In some implementations, the performance and capability of a mobile display device may be improved by increasing the channel capacity for transferring data wirelessly. Methods to increase the channel capacity include increasing the bandwidth of the communication link, improving the signal-to-noise (S/N) ratio for the system, or adding antennas with adequate diversity to either or both sides of the link (upstream and downstream). FIG. 1 is an example of a graph illustrating channel capacity as a function of the number of antennas, assuming independent and identically distributed sources of noise. The Shannon-Hartley capacity theorem relates channel capacity C as a function of bandwidth B and logarithmically with the signal-to-noise ratio S/N. This may be expressed as

C=B*log₂(1+S/N)

with the bandwidth B in Hertz and the channel capacity C in bits per second. Hence, achieving higher data rates may involve increasing the signal bandwidth or increasing the S/N ratio. The use of MIMO systems with multiple antennas may further increase the channel capacity. MIMO antenna systems may use multiple antennas at the transmitter and the receiver end. Multiple independent data streams may be transmitted and received by the antennas at each end of the link. Note that the number of streams may be less than or equal to the lower of the number of antennas at either end. The Shannon-Hartley capacity theorem may be modified in MIMO antenna systems to include the number of streams M.

C=M*B*log₂(1+S/N)

In FIG. 1, the normalized channel capacity (C/B) linearly increases with the number of antennas. The potential number of streams is largely correlated with the number of antennas. In this case, the signal-to-noise ratio is set to 16 dB. Thus, multiple antennas in a display device may increase data rates two-fold, four-fold, ten-fold or more. Note that if the streams are not independent or have correlated noise sources, the channel capacity C may be appreciably less than that shown.

Multiple antenna schemes are not limited to MIMO antenna configurations. Multiple antenna schemes may also take advantage of antenna diversity to improve overall device performance. The basic concept of antenna diversity is to transmit a signal via several independent paths to get independent signal copies at the receiver via spatial diversity, frequency diversity, temporal diversity, polarization diversity, and/or other diversity types. This may mitigate the undesirable effects of fading and other types of attenuation loss, and allow the receiver to select the signal with the highest signal quality. Signal quality can be evaluated based on various quantities and/or parameters, including, but not limited to, signal-to-noise ratio, signal strength, bit error rate, data transmission rate, and fading condition.

Spatial diversity may employ multiple antennas that are physically separated from one another, which may be on the order of about one to five wavelengths or more apart. Spatial diversity may improve the robustness of the signal by providing multiple copies of the same signal propagating in space. This may reduce the probability that different signal paths between the transmitter and the receiver undergo the same amount of fading, for example. Spatial diversity may be achieved using multiple transmitter antennas and/or multiple receiving antennas. Spatial diversity may also be a part of a MIMO antenna system.

To benefit from frequency diversity, signals may be transmitted over multiple channels having different carrier frequencies, or the signal may be spread over a wide spectrum that may have portions affected by frequency-dependent fading or attenuation. Antenna configurations and systems that transmit the signal over different frequencies may reduce the effects of frequency-dependent fading or attenuation, for example.

Temporal or time diversity involves transmitting the same parts of a signal at different instances in time. Temporal diversity may be used to reduce the effects of error bursts due to time-varying channel conditions, which may be caused by fading in combination with a moving receiver, transmitter, or obstacle, or by intermittent electromagnetic interference or co-channel interference.

Polarization diversity takes multiple versions of the signal and transmits them with different polarizations. In some implementations, the antennas may be linearly polarized (e.g., horizontal/vertical) or circularly polarized (left-hand or right-hand), although other polarizations (e.g., elliptical) are possible. Pairs of antennas may be configured to have orthogonal polarizations that may result in increased signal strength from one or the other. By pairing complementary polarizations, an antenna array may be further immunized from polarization mismatches and signal fading.

Many display devices, including cellular phones, smart phones, e-readers, and tablet computers, have limited space to position antennas for wireless communications. Antennas may be limited to incorporation in or on the device enclosure, which generally limit antenna gain, efficiency, and directionality. These limitations on antenna configurations may further restrict opportunities to take advantage of antenna diversity and spatial multiplexing, as discussed earlier herein, as well as opportunities for beam steering and adaptive antenna arrays.

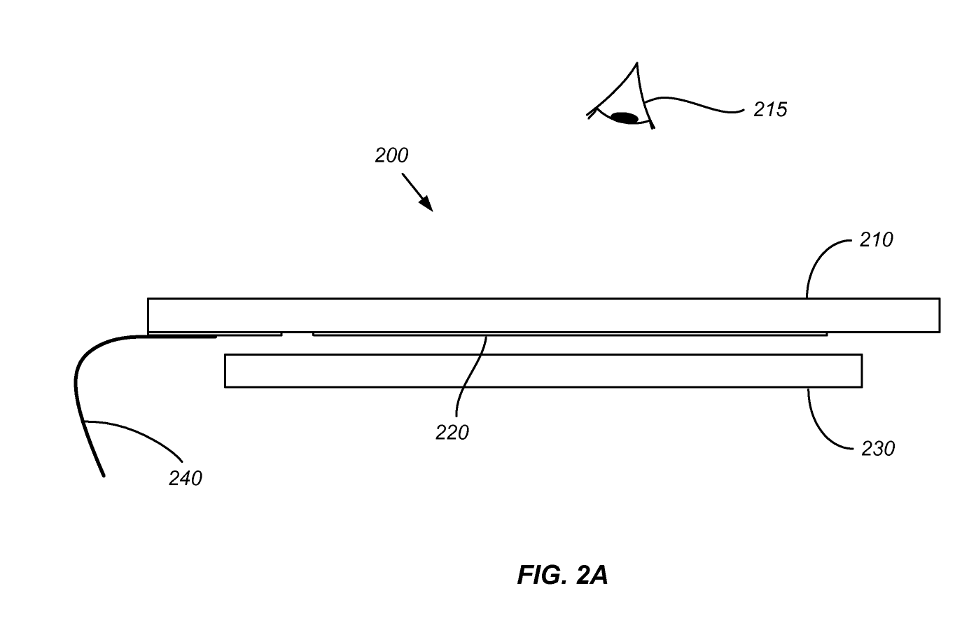

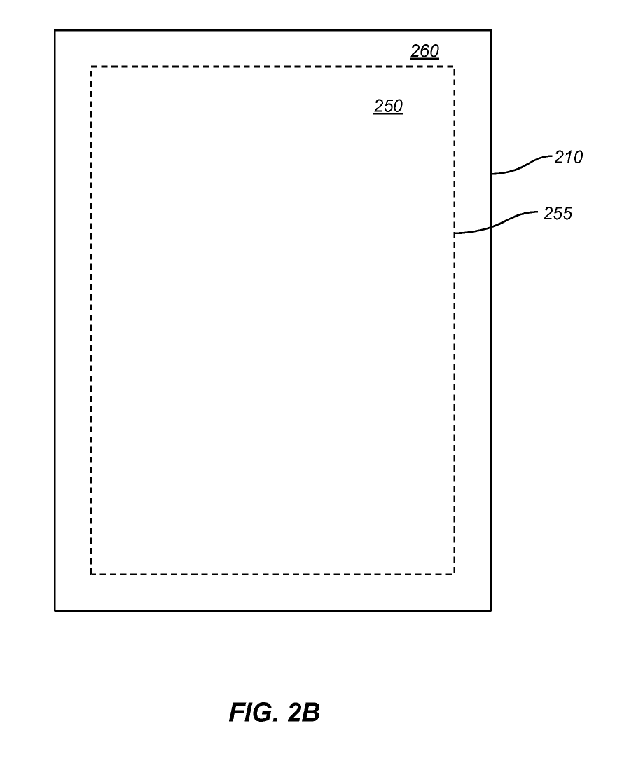

In some implementations, antennas may be placed on or in front of a display of a display device. FIG. 2A is an example of a cross-sectional side view schematic illustration of an antenna in front of a display of a display device. The display device 200 may include a transparent substrate 210 over a display 230. In some implementations, the transparent substrate 210 may be made of glass, plastic, or other substantially transparent material. The transparent substrate 210 may be, for example, an antenna panel, a cover plate, a cover glass, a touch panel, a front light, or a display glass. In some implementations, the antenna(s) may be on a backplane or back plate of the display device, or configured behind or under the display such as on or part of a backlight (not shown). The display 230 may include any suitable display type, such as a transmissive display, a reflective display, or a self-emitting display. For example, the display 230 may include an IMOD display, a liquid crystal display (LCD), an OLED display, a micro-shutter based display, or other type of display.

As illustrated in the example in FIG. 2A, an antenna 220 may be formed on a transparent substrate 210. Some examples of such a transparent substrate 210 have been provided above. An image (not shown) may be formed on the display 230. In some implementations, the transparent substrate 210 with the antenna 220 may be positioned on a display side of the display device 200 to allow a viewer 215 to see images produced by the display 230 while avoiding substantial interference with the produced images. Positioning the antenna 220 on the display side may provide more direct pathways for incident and transmitted radio-frequency signals than an antenna enclosed inside the display device. Forming an antenna 220 on the transparent substrate 210 or otherwise configuring the antenna on the display side of the display device 200 may provide additional space to allocate antennas on or within the display device 200. With more space, multiple antennas including antenna 220 may open opportunities in the display device 200 for multiple frequency bands, antenna diversity, and spatial multiplexing, along with beam steering and adaptive antenna arrays. Beam steering can increase the effective RF signal strength by directing RF energy selectively towards a receiving antenna, allowing higher signal-to-noise ratios and/or a reduction in transmitting power. Adaptive antenna arrays allow one or more antennas in an array to selectively transmit and receive signals with increased directionality.

In some implementations, the antenna 220 may be transparent or substantially transparent. A transparent antenna may include an antenna made of a transparent conductive material, such as a transparent conductive oxide. For example, a transparent conductive oxide may include ITO. In some implementations, a transparent antenna may include an antenna made of very narrow electrically conductive traces, such as a mesh structure of electrically conductive material, irrespective of whether the electrically conductive material is transparent itself. In some implementations, the transparent antenna may include an antenna formed from a transparent conductive material that is augmented or electrically reinforced with narrow traces of conductive material (which may be non-transparent). Transparency as used herein is defined as transmittance of visible light of about 70% or more, such as about 80% or more or about 90% or more. An empirical definition of transparency for the transparent antenna is the fraction of light transmitted through the transparent antenna at which a displayed image may still be effectively viewed by a viewer. With highly emitting OLED displays or with high-intensity backlights for LCD displays, the transparency of the antenna panel may be below about 70% and still be considered transparent or substantially transparent.

The display device 200 may further include one or more antenna feed lines 240 connected to the antenna 220. The antenna feed lines 240 allow electrical connections between a radio transmitter or receiver and the antenna 220. The antenna feed lines 240 may provide radio frequency (RF) current or voltage from the transmitter to the antenna 220, or transfer RF current or voltage from the antenna 220 to the receiver. In some implementations, the antenna feed lines 240 may include but are not limited to a coaxial cable, a twin-lead cable, a twisted pair, a wire, a cable, a flex tape, a transmission line, an impedance-matched flex tape, a coplanar waveguide, or a through-substrate via. The antenna feed lines 240 may be attached to the transparent substrate 210 with solder, anisotropic conductive film (ACF), a clamp, a socket, or other suitable technique.

FIG. 2B is an example of a topside view of a transparent substrate having a display region and a non-display region. The transparent substrate 210 has a display region 250 through which an image may be displayed and viewed, and a non-display region 260 that surrounds at least a portion of a perimeter 255 of the display region 250. Non-display region 260 may correspond, for example, with regions on an underlying display (not shown) where traces and other connecting features for the display are located. One or more antennas (not shown) may be formed in either the display region 250 or the non-display region 260 or both.

FIG. 2C is an example of a cross-sectional side view schematic illustration of an antenna panel behind a display of a display device. The antenna panel 270, which may be transparent or non-transparent, includes one or more transparent or non-transparent antennas 220a-d that may be formed on a transparent or non-transparent substrate. In some implementations, the antenna panel 270 may be attached to or formed as part of a backlight or a back plate of the display 230, and positioned in an enclosure (not shown) of a mobile display device 200. An optional cover glass 280 may be positioned in front of the display 230. The cover glass 280 may also include one or more transparent antennas (not shown).

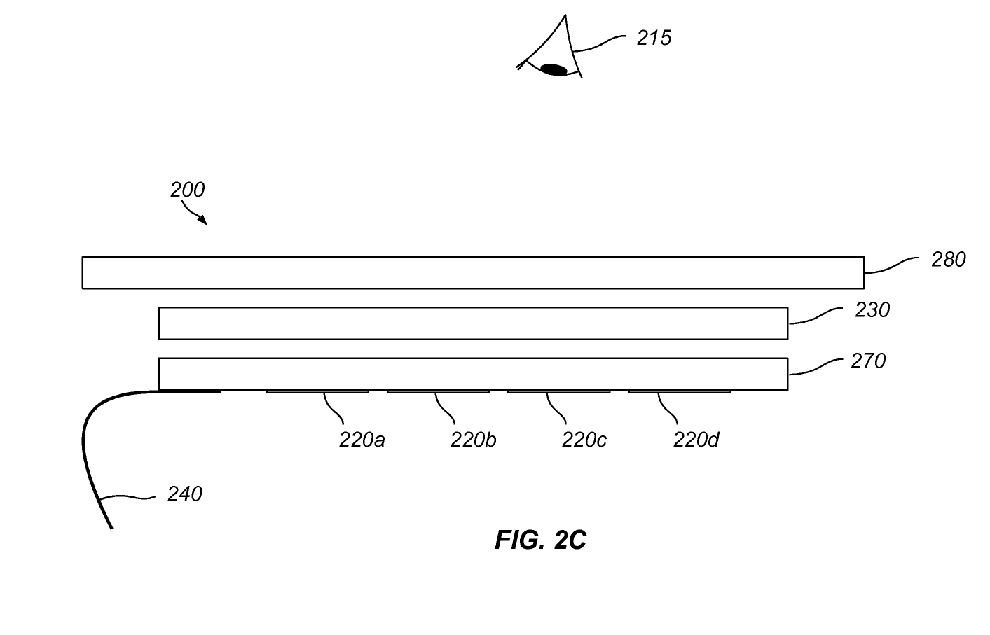

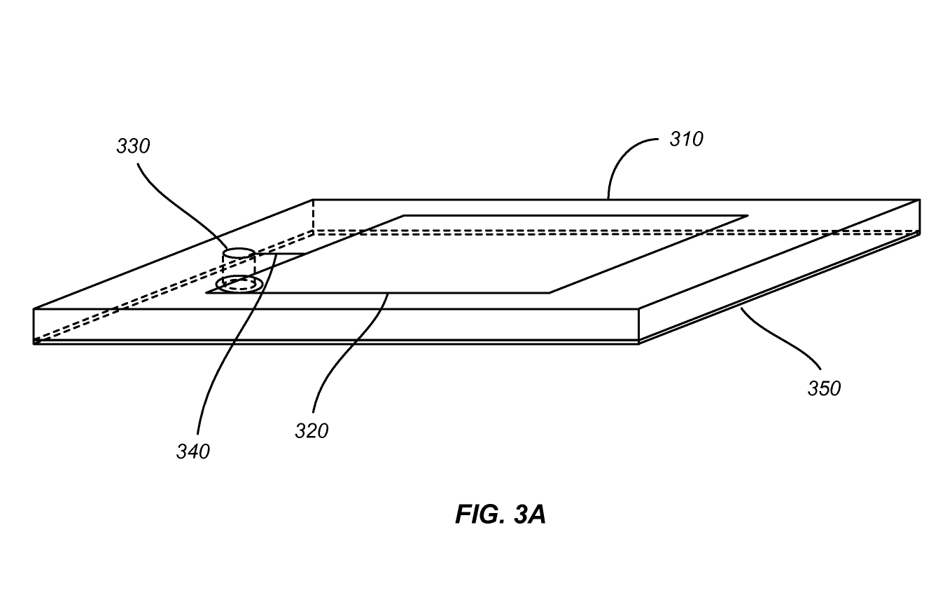

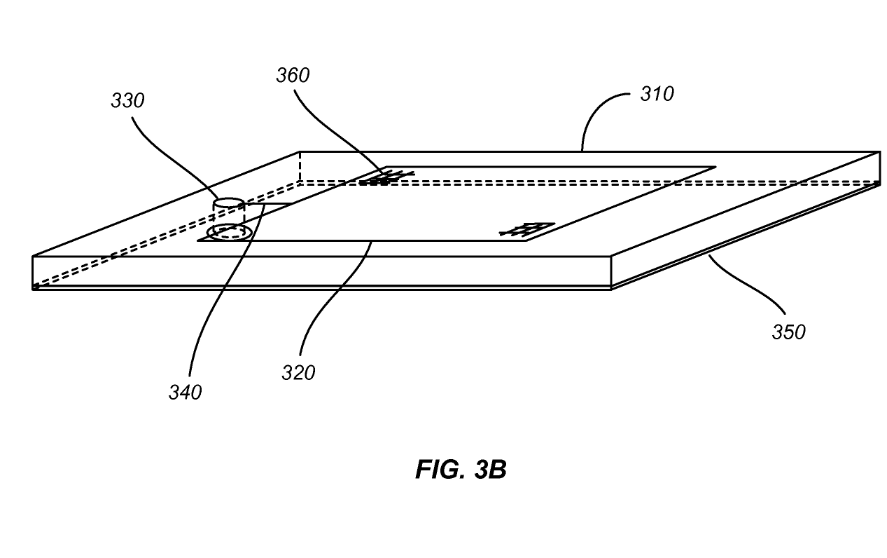

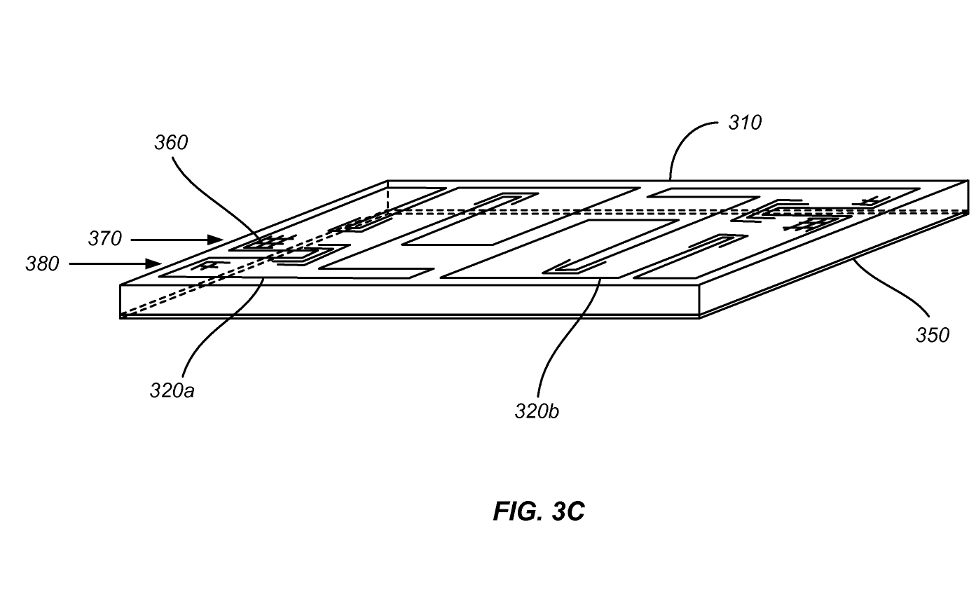

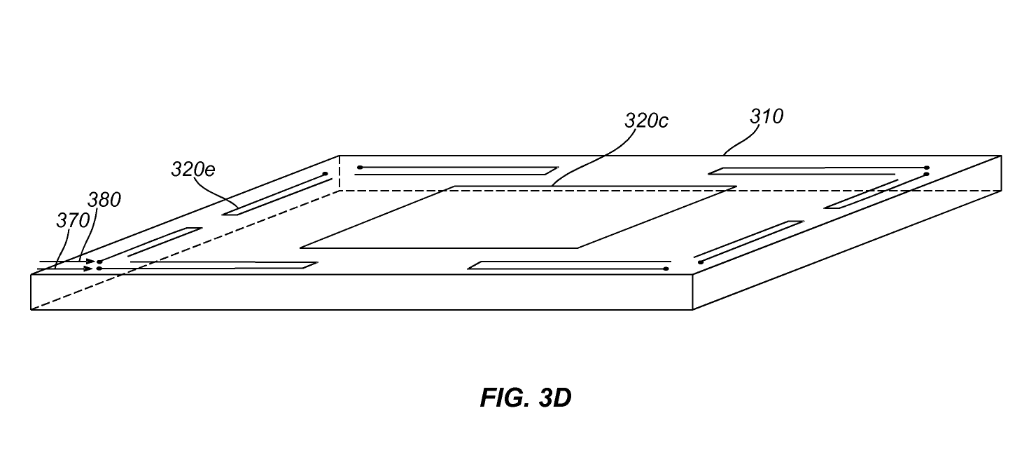

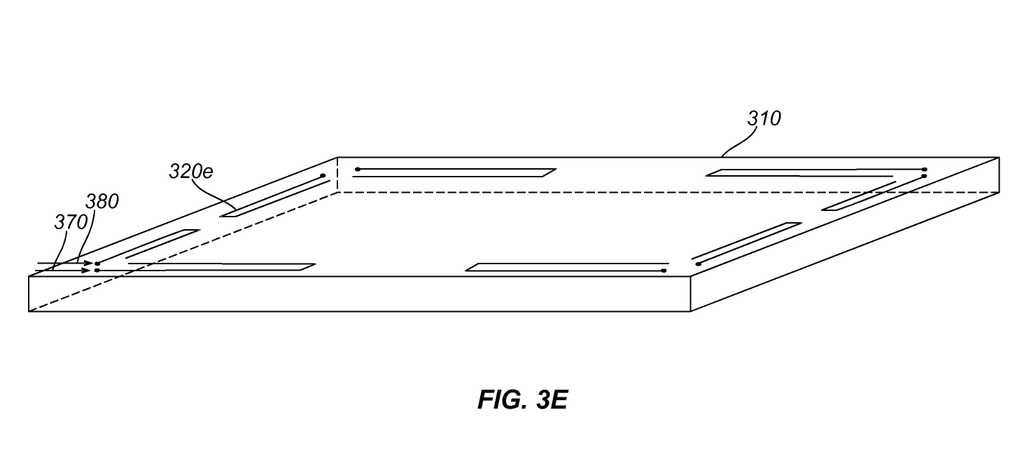

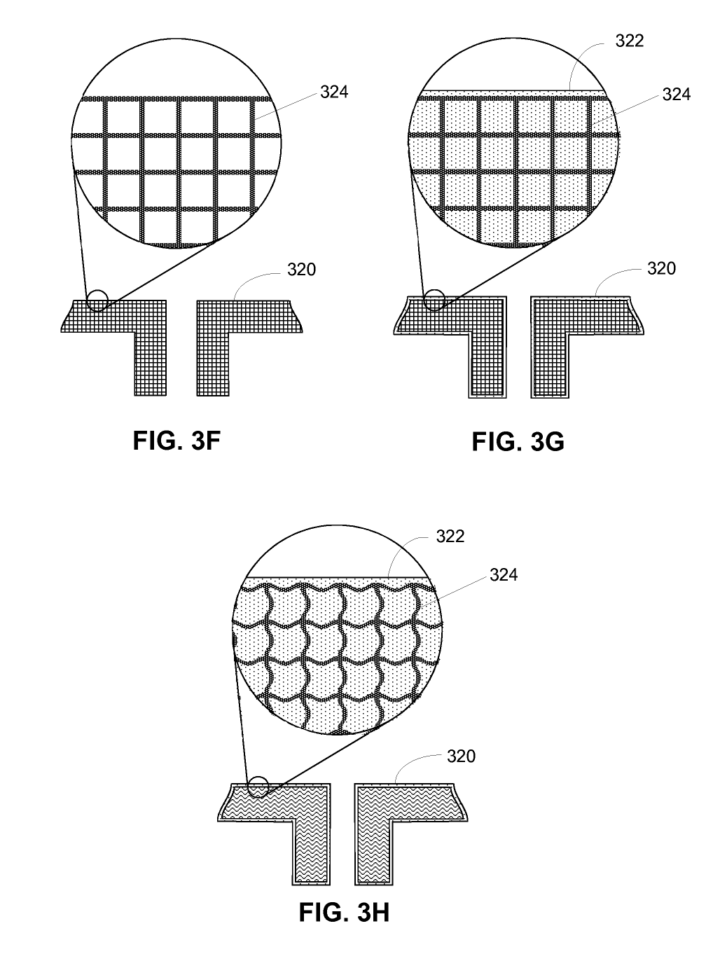

FIG. 3A is an example of a perspective view of a transparent antenna on a transparent substrate. A transparent antenna 320 may be formed on a surface of a transparent substrate 310. As illustrated in the example of FIG. 3A, the transparent antenna 320 may be a patch antenna. The transparent antenna 320 may be substantially planar with the transparent substrate 310 and may have any suitable size or shape. For example, the transparent antenna 320 may be square, round, or rectangular in shape. In some implementations, the transparent antenna 320 may cover a substantial portion of a surface of the transparent substrate 310. Because of the relatively large area that the transparent antenna 320 may encompass on the transparent substrate 310, larger and more efficient antennas 320 may be formed. In some implementations, the transparent antenna 320 may be one-half or a full wavelength long. In some implementations, the transparent antenna 320 may be formed from a substantially transparent conductive thin film deposited or otherwise attached to the transparent substrate 310. The thickness of the transparent substrate may be between about 10 μm and about 700 μm. The conductive thin film may have a thickness between about 10 nm and about 10 μm. In some implementations, the transparent antenna 320 may be formed from a gridwork of relatively narrow electrically conductive traces, which may have a thickness between about 10 nm and about 10 μm or more. The width of the electrically conductive traces may be between about 1 μm and about 10 μm to limit the potential occlusion of a displayed image. In some implementations, the width of the conductive traces may be between about 3 μm and about 5 μm. In some implementations, the transparent antenna 320 may be formed from a substantially transparent conductive thin film such as ITO that is electrically reinforced locally with narrow traces of a non-transparent electrically conductive metal or a substantially black interferometric stack structure. In some implementations, the substantially black interferometric stack structure may be formed from a multi-layer composite of materials including an absorber, a dielectric, and a reflector, with the dielectric serving as an optical cavity between the absorber and the reflector. The material stack is sometimes referred to as a black matrix, a black mask, or a black stack. To a viewer, this combination may appear dark or substantially black. Dark features may aid in retaining the contrast of an underlying display.

The transparent antenna 320 may be electrically coupled to a ground plane 350. In the example illustrated in FIG. 3A, the ground plane 350 may be formed on a surface of the transparent substrate 310 opposite the transparent antenna 320. For a patch antenna as illustrated in FIG. 3A, the transparent antenna 320 is on a different plane than the ground plane 350. However, the ground plane 350 may be formed on other parts of the transparent substrate 310, or positioned external yet proximal to the transparent substrate 310. In some implementations, the ground plane 350 may be transparent or substantially transparent. For example, the ground plane 350 may be made of ITO or other transparent conductive material, a mesh or grid of narrow traces of metal or a black stack, or a composite of transparent conductive material augmented with narrow traces of metal or a black stack.

A through-substrate via (TSV) 330 or through-glass via (TGV) may extend between two sides of the transparent substrate 310 to provide backside electrical interconnection to the transparent antenna 320 as shown in FIG. 3A. The TSV 330 may be transparent or non-transparent and may include a via hole that is coated or filled with one or more transparent or non-transparent conductive materials. In some implementations, the TSV 330 may include a transparent conductive oxide such as ITO and/or a transparent conductive polymer, a nanotube-filled resin, a metal nanowire-filled resin, a particle-filled resin, a metal particle-filled resin, or other suitably conductive material. In some implementations, the TSV 330 may be formed from an electroplated or deposited metal. The TSV 330 may be connected to the transparent antenna 320 via a feed line 340. The feed line 340 and the TSV 330 provide a conductive pathway from the transparent antenna 320 through the substrate 310 to allow electrical connections on the backside of substrate 310 along with electrical connections to the ground plane 350. In some implementations, electrical interconnections to the transparent antenna 320 and the ground plane 350 may be made on the topside or the bottom side of transparent substrate 310 without a conductive via using a coaxial cable, a flex tape, a waveguide, or other suitable means. In some implementations, a TSV 330 may locally connect a portion of the transparent antenna 320 directly with a portion of the ground plane 350.

The transparent antenna 320 may be made of a transparent conductive material such as ITO. Thus, the transparent antenna 320 may be positioned in a display region of the transparent substrate 310. However, as transparent conductive materials typically have high resistivity, the transparent conductive material may unduly attenuate a radio-frequency signal, resulting in low antenna gain. Therefore, a transparent antenna 320 such as the patch antenna illustrated in FIG. 3A may provide insufficient antenna performance by itself.

FIG. 3B is an example of a perspective view of a transparent antenna with electrically conductive traces on a transparent substrate. In some implementations, the transparent antenna 320 may be a patch antenna. The electrically conductive traces 360 may be formed on the transparent antenna 320 and configured to electrically reinforce the transparent antenna 320. The transparent antenna 320 and the electrically conductive traces 360 formed thereon may include different materials.

Since the transparent antenna 320 formed of a transparent conductive oxide such as ITO may conduct electricity relatively poorly, the electrically conductive traces 360 may electrically reinforce the transparent antenna 320. In some implementations, the electrically conductive traces 360 may be made of lower resistivity material than the transparent antenna 320. In some implementations, the electrically conductive traces 360 may have a greater thickness than the transparent antenna 320. In some implementations, the electrically conductive traces 360 may modify the local and overall impedance of the transparent antenna, lowering the resistance to reduce internal losses and improving matching with free space to reduce transmission and receiving losses. Therefore, the electrically conductive traces 360 may electrically reinforce the transparent antenna 320 to reduce antenna losses.

In some implementations, the electrically conductive traces 360 may be formed in a non-display region of the transparent substrate 310. The transparent substrate 310 may include a surface having a display region and a non-display region that surrounds at least a portion of the perimeter of the display region. Thus, the electrically conductive traces 360 may avoid occluding an image (not shown) in the display region of the transparent substrate 310 by placing the traces in the non-display region, such as to provide low-resistance feed lines or to selectively reinforce the transparent antenna in regions outside of the display region. In addition, the width of the electrically conductive traces 360 may be between about a few micrometers and several millimeters. Hence, the electrically conductive traces 360 may improve the antenna performance without obstructing a users' view of the display region, regardless of whether the electrically conductive traces 360 are in the display region or non-display region of the transparent substrate 310.

In some implementations, the electrically conductive traces 360 may be very narrow and made of relatively low-resistivity metals. For example, the electrically conductive traces 360 may include at least one of aluminum, an aluminum alloy, aluminum-silicon, copper, chromium, molybdenum, molybdenum-chromium, or silver. Though the electrically conductive traces 360 may be made of material that is non-transparent to visible light, the electrically conductive traces 360 may be sufficiently narrow to appear to be substantially transparent to a viewer of the display. For example, the width of the electrically conductive traces 360 may be between about 10 nm and about 10 μm or larger, and typically between about 1 μm and about 5 μm for patterned features. Some configurations may include thin meshes of copper and/or silver nanowires. The electrically conductive traces 360 may be positioned in the display region of the transparent substrate 310 without substantially interfering with images formed in the display region. In some implementations, the electrically conductive traces 360 may be formed from a multi-layer composite of materials including an absorber, a dielectric, and a reflector, with the dielectric serving as an optical cavity between the absorber and the reflector. The material stack is sometimes referred to as a black matrix, a black mask, a substantially black interferometric stack structure, or a black stack. To a viewer, this combination appears dark or substantially black. Dark features may aid in retaining the contrast of an underlying display.

FIG. 3C is an example of a perspective view of multiple antennas on a transparent substrate. Each of the antennas 320a and 320b may be transparent or substantially transparent and may be formed on a surface of the transparent substrate 310. As illustrated in the example in FIG. 3C, each of the transparent antennas 320a and 320b may be a planar inverted-F antenna (PIFA). PIFAs may be resonant at a quarter-wavelength and may occupy less space than a patch antenna. PIFAs may have a low profile on the order of the thickness of the transparent substrate 310 and may have a largely omnidirectional pattern.

In some implementations, the transparent antennas 320a and 320b may be spaced apart to provide spatial diversity. By having multiple antennas 320a and 320b on the transparent substrate 310 with spatial diversity, the robustness and data rates of wireless transmissions may improve. In some implementations, the transparent antenna 320b is arranged in a rotated configuration from the transparent antenna 320a. Flipped or rotated antenna configurations may allow feed lines for each antenna to be located at the periphery of the transparent substrate 310 for ready connection with external circuitry.

In some implementations, each of the transparent antennas 320a and 320b may have one or more slots formed in the transparent antennas 320a and 320b. Each of the slots may correspond to different operating frequencies to allow multi-band operation and/or frequency diversity in the transparent antennas 320a and 320b. By having one or more slots, multiple communication bands may be accommodated with the same antenna. In the example illustrated in FIG. 3C, the transparent antennas 320a and 320b are triple-band antennas that may receive and transmit signals in at least three different frequency ranges.

In some implementations, the transparent antennas 320a and 320b may have different operating frequencies. With higher frequencies, the size of the antenna generally reduces. At frequencies between about 2-3 GHz to about 60 GHz and above, one or more transparent antennas 320a and 320b may be readily placed on the transparent substrate 310 for use in front of a display of a mobile display device. At higher frequencies where the current density occurs increasingly closer to the surface of a conductor, the skin depth for the RF excitations is reduced, allowing the use of a relatively thin conductive film with minimal loss. The transparent antennas 320a and 320b may have different operating frequencies. Either or both transparent antennas 320a and 320b may accommodate one or more standards or protocols including but not limited to GPS, a Bluetooth protocol, WLAN, a Wi-Fi network, a WiMax network, an RFID band, an NFC band, an HDTV band, an FM band, a MIMO system, or a UWB protocol. Although shown with two antennas 320a and 320b, three or more antennas of the same or different type may be included on the transparent substrate 310.

In some implementations, one or more electrically conductive traces 360 may be formed on portions of or throughout the transparent antennas 320a and 320b to improve the antenna performance. The electrically conductive traces 360 may electrically reinforce the transparent antennas 320a and 320b, increasing the effective conductivity of the antennas 320a and 320b in places where the electrically conductive traces 360 are located, such as near bends or interior corners of the antennas 320a and 320b where the current density is larger. The transparent antennas 320a and 320b may be formed of different materials from the electrically conductive traces 360. In some implementations, the electrically conductive traces 360 may be made of lower resistivity material than the transparent antennas 320a and 320b or have a greater thickness than the transparent antennas 320a and 320b. For example, ITO may have a resistivity of about 9.3 ohm-cm, whereas copper and aluminum may have resistivities between about 1.7×10⁻⁶ and 2.8×10⁻⁶ ohm-cm. Generally, the electrically conductive traces 360 lower the impedance of the transparent antennas 320a and 320b in regions where the traces are located. Therefore, where the resistivity or resistance of each of the non-reinforced transparent antennas 320a and 320b is too high, the electrically conductive traces 360 may locally and electrically reinforce parts of the transparent antennas 320a and 320b to reduce antenna losses and improve antenna matching.

In some implementations, the electrically conductive traces 360 may be formed in a non-display region of the transparent substrate 310. The width of electrically conductive traces 360 in a non-display region may be wider than those in a display region, as no portions of a displayed image are blocked. For example, the width of the electrically conductive traces 360 may extend from a few microns to a few millimeters wide or more for many display devices. In some implementations, the electrically conductive traces 360 may form part of a low-resistivity metal grid or mesh in the display region or the non-display region of the transparent substrate 310. The electrically conductive traces 360, in some implementations, may have widths between about 1 μm and about 10 μm. In some implementations, the width of the electrically conductive traces 360 may be reduced in the display region compared to the width of the electrically conductive traces 360 in the non-display region, such that the electrically conductive traces 360 in the display region are less visible to a viewer of the display. Other techniques may be applied to reduce the visibility of the electrically conductive traces 360 in either the display region or the non-display region. For example, the electrically conductive traces 360 may be formed from a grid of a black interferometric stack structure, such that the traces appear dark or substantially black to a viewer. In another example, the electrically conductive traces 360 may have curvilinear features such as successively interconnected arcs or randomized segments that make the traces 360 less visible to a viewer.

In some implementations, the electrically conductive traces 360 may be formed in regions of high current density in the transparent antennas 320a and 320b. Regions of high current density may occur where the transparent antennas 320a and 320b have slots and/or bends. Such regions may be electrically reinforced with electrically conductive traces 360. Thus, the electrically conductive traces 360 may be formed proximate to slots and/or bends in the transparent antennas 320a and 320b.

In the example in FIG. 3C, the transparent substrate 310 may also include a ground plane 350 on a surface of the transparent substrate 310 opposite the transparent antennas 320a and 320b. In some implementations, the ground plane 350 may be formed on parts of the transparent substrate 310 separate from the transparent antennas 320a and 320b, or outside of the transparent substrate 310 itself such as on another layer or as part of the display. The ground plane 350 may also be substantially transparent. For example, the ground plane 350 may be made of ITO or other transparent conductive material. The ground plane 350 may be electrically reinforced with electrically conductive traces or grids (not shown). In some implementations, the ground plane 350 may be formed from an array of narrow electrically conductive traces such as a grid or mesh with a small fill factor such that the traces are substantially transparent to a viewer. The narrow traces may be on the order of about one to ten microns wide to avoid substantially occluding a user's view of a displayed image. In some implementations, the grid may be formed from narrow traces of a metal or a black stack. The fill factor may be less than about 10 percent to retain high viewability, and in some implementations the fill factor may be less than about 5 percent.

A portion of the transparent antennas 320a and 320b may be in direct electrical communication with a portion of the ground plane 350. For example, a transparent TGV or TSV (not shown) may extend through the transparent substrate 310 and electrically connect the transparent antennas 320a and 320b directly with a portion of the ground plane 350. Radio-frequency signals may be applied to each antenna 320a and/or 320b via one or more feed lines 370 and 380. In some implementations, feed line 370 serves as a ground line and feed line 380 serves as a signal line. In some implementations, feed lines 370 and 380 are differentially driven or differentially received. External connections are generally provided between transparent antennas 320a and 320b and associated RF transmitter and receiver circuitry. For example, feed lines 370 and 380 may be connected to a duplexer. In one example, feed lines 370 and 380 for one or both transparent antennas 320a and 320b are connected to external RF circuitry via an impedance-matched flex tape. Other examples for connection with the transparent antennas 320a and 320b include a coaxial cable, a twin-lead cable, a twisted pair, a wire, a cable, a flex tape, a transmission line, a waveguide, or other suitable means.

FIG. 3D is an example of a perspective view of a transparent antenna in a display region of a transparent substrate and one or more antennas in a non-display region of the transparent substrate. The transparent substrate 310 may be partitioned so as to provide a display region through which an image may be displayed, and a non-display region through which no image is displayed. The transparent antenna 320c may be formed in the display region of the transparent substrate 310. One or more transparent or non-transparent antennas 320e may be cooperatively coupled with the transparent antenna 320c. As illustrated in the example in FIG. 3D, the transparent or non-transparent antennas 320e may be formed on the same surface of the transparent substrate 310 as the transparent antenna 320c. In some implementations, the transparent or non-transparent antennas 320e may be formed in the non-display region of the transparent substrate 310, where the non-display region surrounds at least a portion of a perimeter of the display region of the transparent substrate 310. The transparent or non-transparent antennas 320e may have a thickness the same or greater than the transparent antenna 320c. The transparent or non-transparent antennas 320e may be formed of a material that is the same as or different than the transparent antenna 320c. In some implementations, the transparent or non-transparent antennas 320e may include narrow conductive traces (not shown) throughout or in select portions of either or both antennas 320c and 320e, and the width of the conductive traces (if used), may be wider or significantly wider in the non-display region. Since the antennas 320e in a non-display region do not substantially interfere with the display region of the display, the antennas 320e may have a thickness between about 0.1 μm to about 50 μm or more.

The transparent antenna 320c may be a patch antenna as illustrated in the example of FIG. 3D. However, the transparent antenna 320c or 320e, like the antennas described with respect to FIG. 2 and FIGS. 3A-3C above and FIG. 3E below, may be any suitable type of antenna such as a dipole antenna, a planar inverted-F antenna (PIFA), a slot antenna, a planar antenna, a meander-line antenna, a fractal antenna, a multi-band antenna, an ultra-wide band antenna, a circularly polarized antenna, a duplex antenna, a cancellation antenna, a beam-forming antenna, a steerable antenna, an adaptive antenna, or a combination thereof.

For example, the transparent or non-transparent antennas 320e may include one or more folded dipole antennas as illustrated in the example of FIG. 3D. The folded dipole antennas may be L-shaped to fit into the corners of transparent substrate 310. Other dipole antennas such as a straight folded dipole or a conventional full or half-wave dipole (non-folded) may be used along one or more sides of transparent substrate 310. The L-shaped folded dipole antenna may have the tips of the antenna folded inwards until they almost meet at the feed points. Feed lines 370 and 380 may connect to the feed points of the folded dipole antenna. The feed points may be interior to the folded dipole antenna, with electrical connections made through, for example, a TGV or a TSV (not shown). The feed points may be exterior to the folded dipole antenna and closer to the periphery of transparent substrate 310 as shown in FIG. 3D, with electrical connections made to the feed points through one or more flex tapes, coaxial cables, twisted pairs, wires, coplanar waveguides, and the like. In some implementations, the feed lines 370 and 380 may include traces (not shown) that cross over or under portions of the antennas to allow connections to external RF circuitry. The folded dipole antenna may be resonant at one entire wavelength. This arrangement for a folded dipole antenna allows for greater bandwidth and higher sensitivity compared to one-half wavelength or one-quarter wavelength antennas. In some implementations, the transparent or non-transparent antennas 320e may be any suitable antenna type, including antenna types discussed earlier herein.

The transparent or non-transparent antennas 320e may be formed at the corners or along the sides of the transparent substrate 310. The transparent antenna 320c and the transparent or non-transparent antennas 320e may be arranged as an array of antennas. Each of the antennas may have at least one of spatial diversity, frequency diversity, temporal diversity, polarization diversity, and other diversity type with the other antennas in the array. In some implementations, each of the transparent or non-transparent antennas 320e may be spatially diverse from one another. In some implementations, the transparent or non-transparent antennas 320e may form part of a MIMO antenna array for spatial multiplexing. This may increase the data rates for wireless communications by two-fold, four-fold, ten-fold, or more. In some implementations, multiple transparent or non-transparent antennas 320e may be used for beam-steering or beam-forming to improve RF signal transmissions.

FIG. 3E is an example of a perspective view of multiple antennas in a non-display region of a transparent substrate. Transparent substrate 310 may have one or more transparent or non-transparent antennas 320e formed or otherwise disposed in a non-display region of the transparent substrate 310. Each of the antennas 320e may have one or more feed lines 370 and 380 to allow electrical connections with external wireless circuitry. Antennas 320e in the non-display region of the transparent substrate 310 does not obscure or otherwise substantially occlude the viewing of the display region of the display device while allowing ready access to the transmission and reception of wireless signals from and to the display device.

FIG. 3F is an example of a detailed view of a grid that forms a portion of a substantially transparent antenna. A portion of a substantially transparent antenna 320 includes a grid or mesh of relatively narrow transparent or non-transparent traces 324. The width of traces 324 is selected to be largely invisible when directly viewed with a human eye, whereas the openings between the traces 324 provide for viewing through the grid with an acceptable loss of transparency. In some implementations, the width of the traces 324 may be between about 1 μm and about 10 μm

FIG. 3G is an example of a detailed view of an electrically reinforcing grid on a substantially transparent antenna. A portion of a substantially transparent antenna 320 includes a grid or mesh of relatively narrow transparent or non-transparent traces 324 disposed on a layer of substantially transparent conductive material 322 such as ITO. The traces 324 may electrically reinforce antenna 320. In some implementations, the traces 324 may provide electrical connection to the feed lines (not shown) of antenna 320.

FIG. 3H is an example of a detailed view of a curvilinear reinforcing grid on a substantially transparent antenna. A portion of a substantially transparent antenna 320 includes relatively narrow transparent or non-transparent traces 324 disposed on a layer of substantially transparent conductive material 322. The traces 324 are shown as curvilinear. Traces 324 with curvilinear segments may have reduced visibility to a user compared to straight segments. As discussed earlier herein, curvilinear features are nonlinear or curved features such as successively interconnected arcs or randomized segments that make the traces 324 less visible to a viewer.

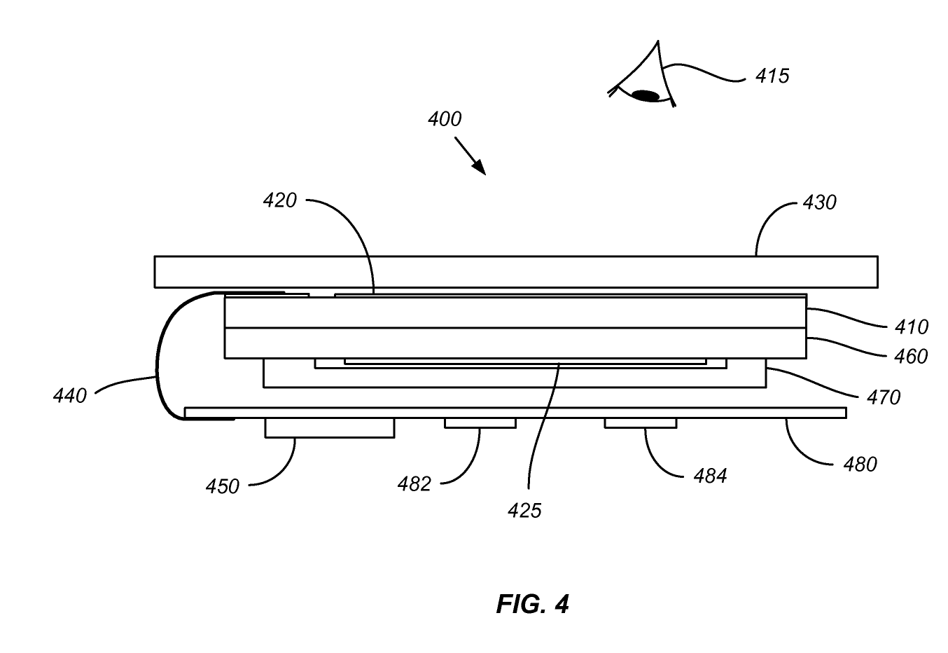

FIG. 4 is an example of a cross-sectional side view schematic illustration of a first antenna on a transparent substrate and a second antenna on a printed circuit board. The display device 400 may include a transparent substrate 410 through which an image (not shown) may be displayed to a viewer 415. The transparent substrate 410 may be an antenna panel, a cover plate, a cover glass, a touch panel, a front light, a display glass, or other layer positioned between the display and a viewer. In the example illustrated in FIG. 4, a first antenna 420 may be disposed on a surface of the transparent substrate 410. In some implementations, the first antenna 420 is substantially transparent. For example, the first antenna 420 may include a transparent conductive oxide such as ITO, a grid of narrow conductive traces, or a transparent conductive material augmented with narrow conductive traces. In some implementations, the first antenna 420 may be substantially non-transparent, such as when the antenna is positioned in a non-display region near the periphery of transparent substrate 410.

The transparent substrate 410 may be formed or otherwise positioned over a display element 425. In some implementations, the display element 425 may be a reflective display element, a transmissive display element, or self-emitting display element. For example, the display element 425 may be an IMOD, LCD, OLED, or other type of display. The display element 425 may be enclosed between a backplane 470 (e.g., a back glass, back plate or backlight) and a display substrate 460 (e.g., a display glass), which may protect the display element 425 from external conditions.

The first antenna 420 may be positioned between the transparent substrate 410 and a cover plate 430. The cover plate 430 may protect the first antenna 420 from ambient conditions and provide scratch protection. While shown on a separate substrate 410, the first antenna 420 may be formed on other parts of the display device 400 such as the cover plate 430, display substrate 460, or backplane 470.

In some implementations, the display device 400 may further include a printed circuit board (PCB) 480 under or behind the display element 425. The PCB 480 may be spaced apart from the display element 425 and the cover plate 430, and enclosed within the display device 400. The PCB 480 may be in electrical communication with the first antenna 420. The PCB 480 may further include an RF module 482 and a processor 484.

A second antenna 450 may be mounted on or otherwise connected to the PCB 480. As illustrated in the example of FIG. 4, the second antenna 450 may be attached to the PCB 480. In some implementations, the second antenna 450 may be formed from traces or features on or within the PCB 480. The second antenna 450 may be substantially non-transparent. In some implementations, the second antenna 450 may be a PCB antenna, a non-transparent metal-film patch antenna, a low-temperature co-fired ceramic (LTCC) antenna, a wire antenna, or other antenna type connected to or formed on or in the PCB 480. The second antenna 450 may be cooperatively coupled to the first antenna 420. The first antenna 420 may be electrically connected to the RF module 482 via one or more feed lines 440 illustrated as a flex tape or a wire connection in FIG. 4. The second antenna 450 may be connected to the RF module 482 via traces on the PCB 480 (not shown) or by some other suitable mechanisms, such as a connector, a cable, or a wire.

The second antenna 450 may be positioned below or behind the display element 425, as illustrated in FIG. 4. In some implementations, the first antenna 420 and the second antenna 450 may be on opposite sides of the display element 425. In such an arrangement, antennas on both sides of the display element 425 may provide exposure to wireless signals independent of orientation, which may be of particular use when the display element 425 exhibits excessive shielding of RF signals.

A substantially non-transparent antenna mounted or otherwise connected to the PCB 480, such as the second antenna 450, is typically small to reduce weight and area on the PCB 480. However, this configuration can reduce direct exposure to incident and transmitted wireless signals because the antenna is buried inside an enclosed space that may have a large number of metallic elements nearby. As a result, the second antenna 450 by itself may experience reduced antenna gain when in an enclosure of the display device 400.

Cooperatively coupling the first antenna 420 with one or more second antennas 450 may increase overall system performance by providing antenna diversity. The first antenna 420 and the second antenna 450 may have at least one of spatial diversity, temporal diversity, frequency diversity, polarization diversity, and other diversity type. In addition, the first antenna 420 and the second antenna 450 may provide opportunities for beam steering and adaptive antenna arrays. Beam steering can increase the effective RF signal strength by directing RF energy selectively towards a receiving antenna, allowing higher signal-to-noise ratios and/or a reduction in transmitting power. Adaptive antenna arrays allow one or more antennas in an array to selectively transmit and receive signals with increased directionality.

Cooperatively coupling the first antenna 420 with the second antenna 450 may increase the channel capacity of the display device 400 via MIMO. In some implementations, the RF module 482 of display device 400 may be configured to selectively switch between the first antenna 420 and the second antenna 450 for receiving (e.g., downloading) and transmitting (e.g., uploading). In some implementations, the first antenna 420 on the transparent substrate 410 may be configured for receiving wireless signals while the second antenna 450 connected to the PCB 480 may be configured for transmitting wireless signals. For example, a display-side antenna or first antenna 420 may be used for improved reception of RF signals while a PCB antenna or second antenna 450 is used for higher-power transmissions from display device 400 to reduce the exposure of RF power to a user. In some implementations, the first antenna 420 or the second antenna 450 may be selected for reception when the signal strength from each antenna has been determined. In some implementations, the transmit frequencies may be different than the receive frequencies, and the antenna 420 or 450 may be selected for transmission or reception based on the frequency. In some implementations with one or more display-side antennas (e.g., first antenna 420) and optionally an enclosed antenna (e.g., second antenna 450), MIMO may be used to increase the transfer rate of data.

Generally, a MIMO system configuration combines multiple transmit antennas and/or multiple receive antennas for the transmission of multiple independent data streams. In some implementations, the first antenna 420 may be part of an array of receive antennas, and the second antenna 450 may be part of an array of transmit antennas, or vice versa. In some implementations, the first antenna 420 and the second antenna 450 may both be a part of an array of receive or transmit antennas.

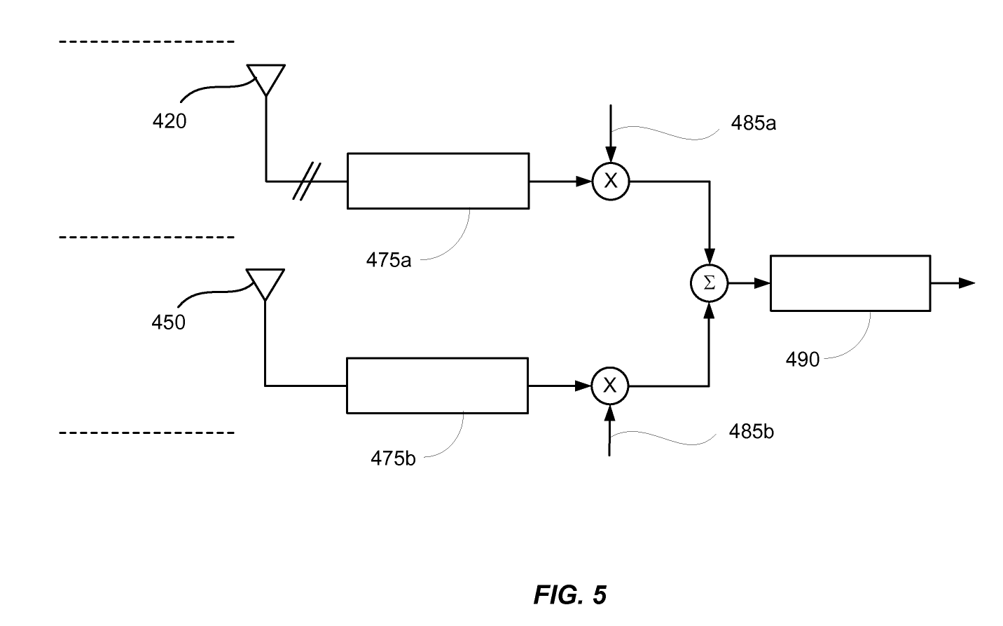

FIG. 5 is an example of a diagram illustrating an operating mode of a multi-antenna system. The elements of FIG. 5 may apply to the first antenna and the second antenna of the display device shown in FIG. 4. The first antenna 420 may be a display-side antenna and the second antenna 450 may be a PCB antenna. Even if the first antenna 420 is lossy compared to the second antenna 450, arranging the first antenna 420 to be cooperatively coupled to the second antenna 450 may increase channel capacity and/or otherwise improve system performance. When arranged in a MIMO system or a multi-antenna system, the first antenna 420 may be cooperatively coupled with the second antenna 450 to improve data throughput.

As shown in FIG. 5, the display device 400 may include a detector 490 and RF modules 475a and 475b electrically connected between antennas 420 and 450 and the detector 490. The first antenna 420 may be configured to receive or transmit wireless signals and the second antenna 450 may be configured to receive or transmit wireless signals. For example, when the first antenna 420 receives a wireless signal, the received wireless signal may be transferred to the first RF module 475a. When the second antenna 450 receives a wireless signal, the received wireless signal may be transferred to a second RF module 475b. A weighting coefficient 485a and 485b may be calculated by the RF modules 475a or 475b, the detector 490, or a wireless communication controller (not shown). The weighting coefficients may effectively serve as an RF switch to selectively switch between antennas 420 and 450, along with any others in the system. In some implementations, the weighting coefficient may depend on the strength of the received or transmitted wireless signal. For example, if a received wireless signal from the first antenna 420 has a higher signal strength than a received wireless signal from the second antenna 450, then the weighting coefficients 485a and 485b may be adjusted to pass the signal from the first antenna 420 into the detector 490. If a received wireless signal from the second antenna 450 has higher signal strength than the received wireless signal from the first antenna 420, then the weighting coefficients 485a and 485b may be adjusted to pass the signal from the second antenna 450 into the detector 490. In some implementations, the weighting coefficients may be based on signal quality. The weighting coefficients 485a and 485b may effectively determine whether an antenna is turned on or off. In some implementations, one or more RF switches (not shown) may be configured to selectively switch between the first antenna 420 and the second antenna 450 and any other antennas in the system for either transmission or reception. When operating in a transmitting mode, the system may select antenna 420, antenna 450, or other display-side or enclosure antenna for the transmission of wireless signals, and switch an RF transmission signal accordingly.

In some implementations, the display device 400 may include a proximity sensor (not shown). A proximity sensor such as a camera or an infrared sensor may be configured to provide input to a controller or processor to allow selective switching of the first antenna 420 and the second antenna 450 for RF transmissions. For example, when the proximity sensor detects a user's head or body proximate to a surface of the transparent substrate 410, RF transmissions from the first antenna 420 may be curtailed and the RF signals sent to the second antenna 450 for transmission.

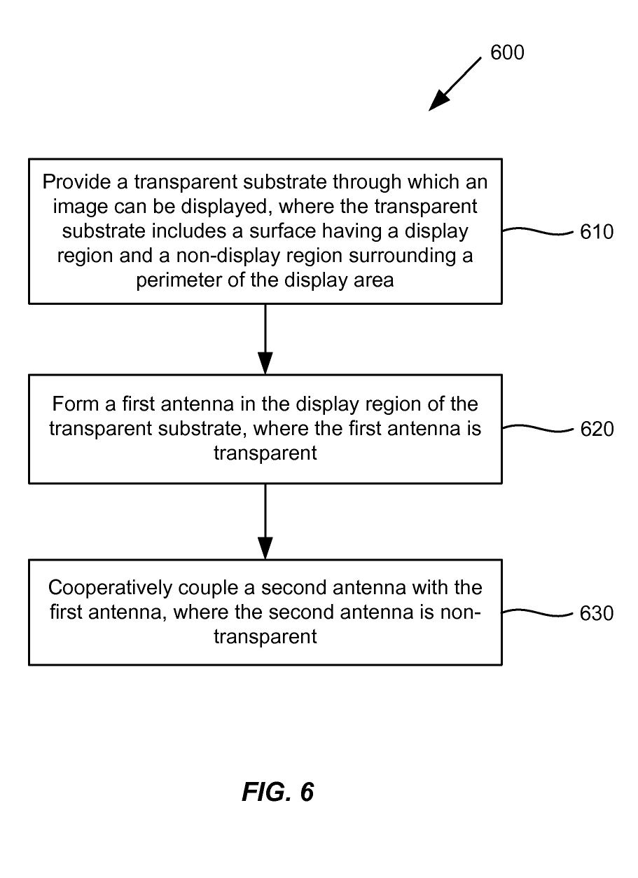

FIG. 6 is an example of a flow diagram illustrating a method of manufacturing a display device. It is understood that additional processes not shown in FIG. 6 may be present. For example, deposition of underlying or overlying layers and features may be achieved by various film deposition processes, such as PVD, PECVD, thermal CVD, ALD, spin-on coating, and electroplating. Patterning techniques, such as photolithography, may be used to transfer patterns on a mask to a layer of material. Etching processes may be performed after patterning to remove unwanted materials.

The process 600 begins at block 610, where a transparent substrate through which an image may be displayed is provided. The transparent substrate may include a surface having a display region and a non-display region that surrounds at least a portion of a perimeter of the display region. In some implementations, the transparent substrate may be made of glass, plastic, or other substantially transparent material. For example, the transparent substrate may be one of an antenna panel, a cover plate, a cover glass, a touch panel, a front light, a display glass, a backplane, a back plate, or a backlight. In some implementations, the transparent substrate may have a thickness between about 10 μm and about 700 μm. In some implementations, the transparent substrate may have a thickness between about 300 μm and 500 μm.

The process 600 continues at block 620, where a first antenna is formed in the display region of the transparent substrate. The first antenna may be transparent or non-transparent. For example, the first antenna may be transparent and positioned in a display region of the transparent substrate. In another example, the first antenna may be transparent or non-transparent and positioned in a non-display region of the transparent substrate. In some implementations, the first antenna may be made of a transparent conductive oxide, such as ITO. In some implementations, the first antenna may include a transparent material and electrically reinforced with narrow, transparent or non-transparent traces. In some implementations, the first antenna may include a grid of narrow, transparent or non-transparent traces. The first antenna may include, for example, a patch antenna, a dipole antenna, a PIFA, a slot antenna, a planar antenna, a meander-line antenna, a fractal antenna, a multi-band antenna, an ultra-wide band antenna, a circularly polarized antenna, a duplex antenna, a cancellation antenna, a beam-forming antenna, a steerable antenna, or an adaptive antenna.

In some implementations, the first antenna may be part of multiple antennas on the transparent substrate. The first antenna may have at least one of spatial diversity, frequency diversity, temporal diversity, polarization diversity, and other diversity type with the other antennas on the transparent substrate.

In some implementations, the first antenna may be augmented or electrically reinforced with electrically conductive traces formed on the first antenna. The electrically conductive traces may be made of aluminum, an aluminum alloy, aluminum-silicon, copper, chromium, molybdenum, molybdenum-chromium, silver, or a combination thereof. The electrically conductive traces may be made of non-transparent material while not substantially occluding the image of the display, and/or the electrically conductive traces may be formed in the non-display region of the transparent substrate to avoid interference with the image of the display.

The process 600 continues at block 630, where a second antenna is cooperatively coupled with the first antenna, and the second antenna is either transparent or non-transparent. In some implementations, a PCB may be provided with the display device and configured to be in electrical communication with the first antenna, where the second antenna is connected or otherwise disposed on the PCB. In some implementations, a display element may be configured between the PCB and the transparent substrate.

In some implementations, the second antenna may be a PCB antenna, a non-transparent metal-film patch antenna, a low-temperature co-fired ceramic (LTCC) antenna, a wire antenna, or another antenna type discussed earlier herein. In some implementations, the second antenna may be transparent or non-transparent, and formed in a non-display region of the transparent substrate. In some implementations, the second antenna may be transparent and formed in the display region of the transparent substrate along with the first antenna. The first antenna and the second antenna may be part of a MIMO system to increase channel capacity. The first antenna and the second antenna may exhibit antenna diversity, including but not limited to at least one of spatial diversity, temporal diversity, frequency diversity, and polarization diversity.

In some implementations, the second antenna may be configured to operate in a different mode from the first antenna. For example, the second antenna may be configured to transmit wireless signals while the first antenna may be configured to receive wireless signals. In some implementations, an RF switch or weighting coefficients that serve as an RF switch may be provided or generated to differentiate and selectively switch between the operating modes.

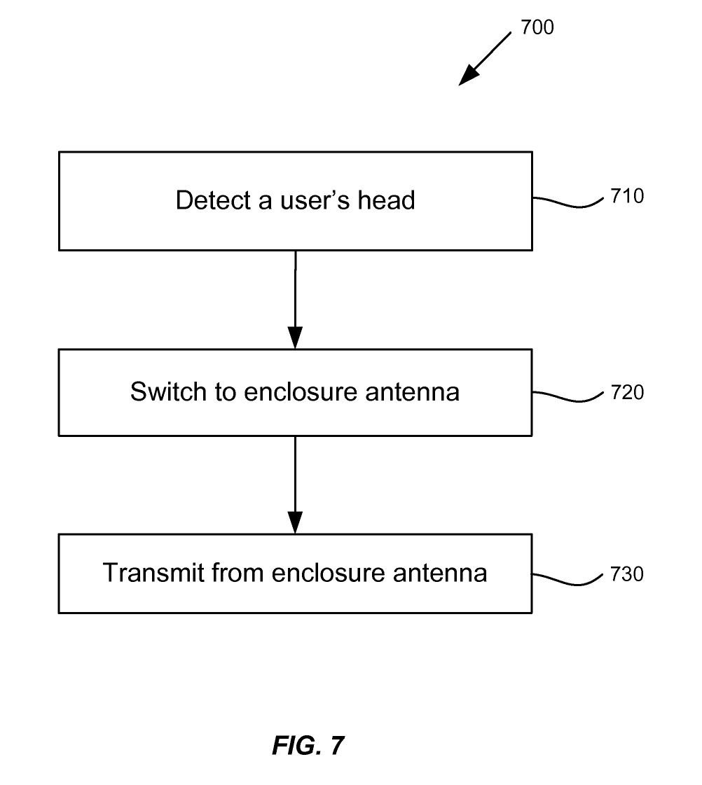

FIG. 7 is an example of a flow diagram illustrating a method of operating a display device. The method 700 can be implemented using hardware (such as application specific integrated circuits (ASIC), programmable logic devices, etc.), software (which includes instructions embodied in a tangible storage medium, executable by a processing device), or a combination of both. The method 700 begins at block 710 where a portion of a user's body such as a head or a face is detected. The head may be detected, for example, with a proximity sensor such as a camera or an infrared sensor coupled to the display device. When a head is detected near a display-side antenna, the display device may switch from the display-side antenna to an enclosure antenna as shown in block 720. The display-side antenna may be disposed on an exterior surface of the display device and the enclosure antenna may be disposed on an interior surface of the display device. The display device may transmit one or more wireless signals from the enclosure antenna as shown in block 730. The display-side antenna may include one or more transparent antennas in a display region above or over a display (such as those discussed above), and/or optionally one or more transparent or non-transparent antennas in a non-display region at the periphery of the display region (such as those discussed above). The enclosure antenna may include one or more PCB antennas or antennas connected to an underlying PCB. In some implementations, the enclosure antenna may include an antenna mounted on a sidewall or back of an enclosure of the display device. In some implementations, the enclosure antenna may extend from an enclosure of the display device. In some implementations, the enclosure antenna may include one or more transparent or non-transparent antennas on an antenna panel positioned under or behind the display. In some implementations, the display device may switch from the enclosure antenna back to the display-side antenna when the head is not proximate the display-side antenna. The display device may receive one or more wireless signals from the display-side antenna. Alternatively, the display device may turn on both the enclosure antenna and the display-side antenna when no body part (e.g., the head, the face, etc.) is detected to be proximate the display-side antenna, and turn off the display-side antenna, keeping the enclosure antenna on, when a specific body part is detected to be proximate the display-side antenna.

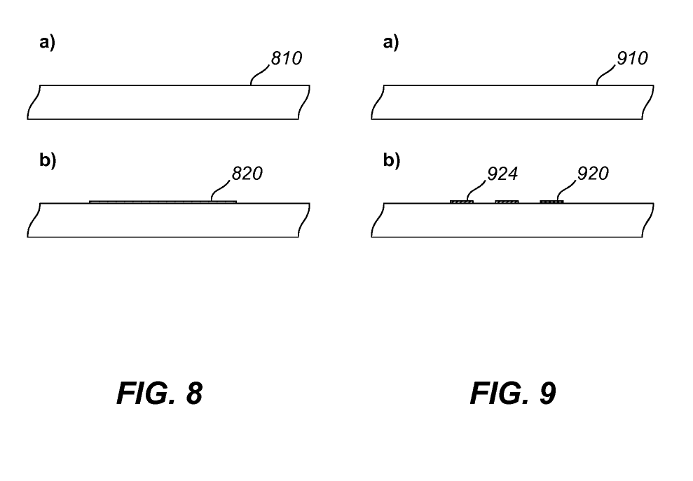

FIG. 8 is an example of a cross-sectional side view illustrating a process sequence for fabricating a transparent antenna. A method for making an antenna panel with one or more transparent antennas includes providing a transparent substrate 810 as shown in FIG. 8a such as a glass or plastic substrate or sheet. A substantially transparent conductive material such as ITO is deposited on the transparent substrate 810 and patterned to form a substantially transparent antenna 820 in a display or non-display region of the transparent substrate 810 as shown in FIG. 8b. A second transparent or non-transparent antenna (not shown) may be formed in a display or non-display region of the transparent substrate 810.

FIG. 9 is an example of a cross-sectional side view illustrating a process sequence for fabricating a transparent antenna with a substantially transparent grid. A method for making an antenna panel with at least one transparent antenna includes providing a transparent substrate 910 as shown in FIG. 9a. A transparent or non-transparent film such as aluminum, chromium, or molybdenum is deposited on the transparent substrate 910 and patterned to form a substantially transparent antenna 920 with relatively narrow traces 924 in a display or non-display region of the transparent substrate 910 as shown in FIG. 9b. Other antennas (not shown) may be formed in a display or non-display region of the transparent substrate 910.

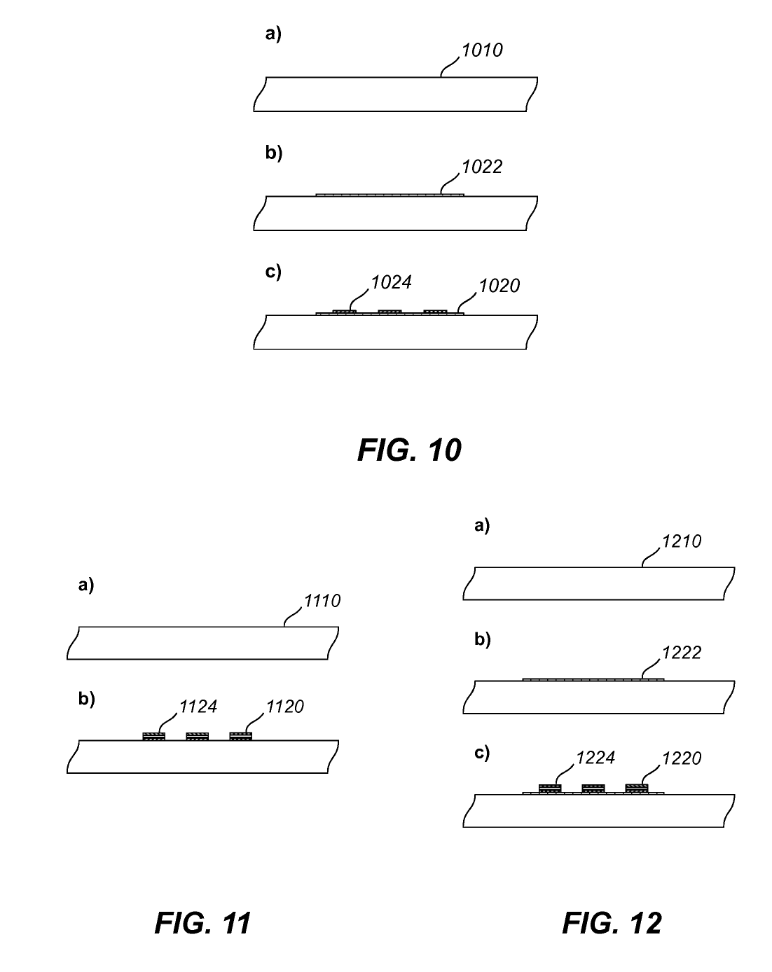

FIG. 10 is an example of a cross-sectional side view illustrating a process sequence for fabricating a transparent antenna with electrically reinforcing traces on a substantially transparent antenna. A method for making an antenna panel with one or more antenna having electrically reinforced traces includes providing a transparent substrate 1010 as shown in FIG. 10a. A layer of substantially transparent conductive material 1022 such as ITO is deposited on the transparent substrate 1010 and patterned to form a substantially transparent antenna 1020 in a display or non-display region of the transparent substrate 1010 as shown in FIG. 10b. A transparent or non-transparent film is deposited on the transparent conductive material 1022 and patterned to form relatively narrow traces 1024 as shown in FIG. 10c.

FIG. 11 is an example of a cross-sectional side view illustrating a process sequence for fabricating a transparent antenna with a substantially transparent grid of a black interferometric stack structure. A method for making an antenna panel with at least one transparent antenna includes providing a transparent substrate 1110 as shown in FIG. 11a. A stack of films including an absorber, a dielectric, and a reflector, which can be referred to as a black stack may be deposited on the transparent substrate 1110 and patterned to form a substantially transparent antenna 1120 having relatively narrow traces 1124 in a display or non-display region of the transparent substrate 1110 as shown in FIG. 11b. In some implementations, the electrically conductive traces 1124 may be formed from a multi-layer composite of a black stack, with a dielectric serving as an optical cavity between the absorber and the reflector. In some embodiments, the stack may be formed of Cr/ITO, Mo/ITO, Ti/ITO, Cr, Mo or Ti as the absorber, SiO₂ as the dielectric, and Al, Cr, Mo, or other metallic material as the reflector. For example, the thickness of the absorber may be on the order of about 6 nm, the thickness of the dielectric may be between about 30 and 80 nm, and the thickness of the reflector may be between about 0.2 μm and about 2.0 μm thick, according to certain implementations. The combination may be selected to appear dark or substantially black to a viewer.

FIG. 12 is an example of a cross-sectional side view illustrating a process sequence for fabricating a transparent antenna with electrically reinforcing traces of a black interferometric stack structure on a substantially transparent antenna. A method for making an antenna panel with one or more substantially transparent antennas having electrically reinforced traces includes providing a transparent substrate 1210, as shown in FIG. 12a. A layer of substantially transparent conductive material 1222 is deposited on the transparent substrate 1210 and patterned to form a substantially transparent antenna 1220 in a display or non-display region of the transparent substrate 1210, as shown in FIG. 12b. A set of layers such as a black stack is deposited on the transparent conductive material 1222 and patterned to form narrow traces 1224 that electrically reinforce the transparent antenna 1220, as shown in FIG. 12c.

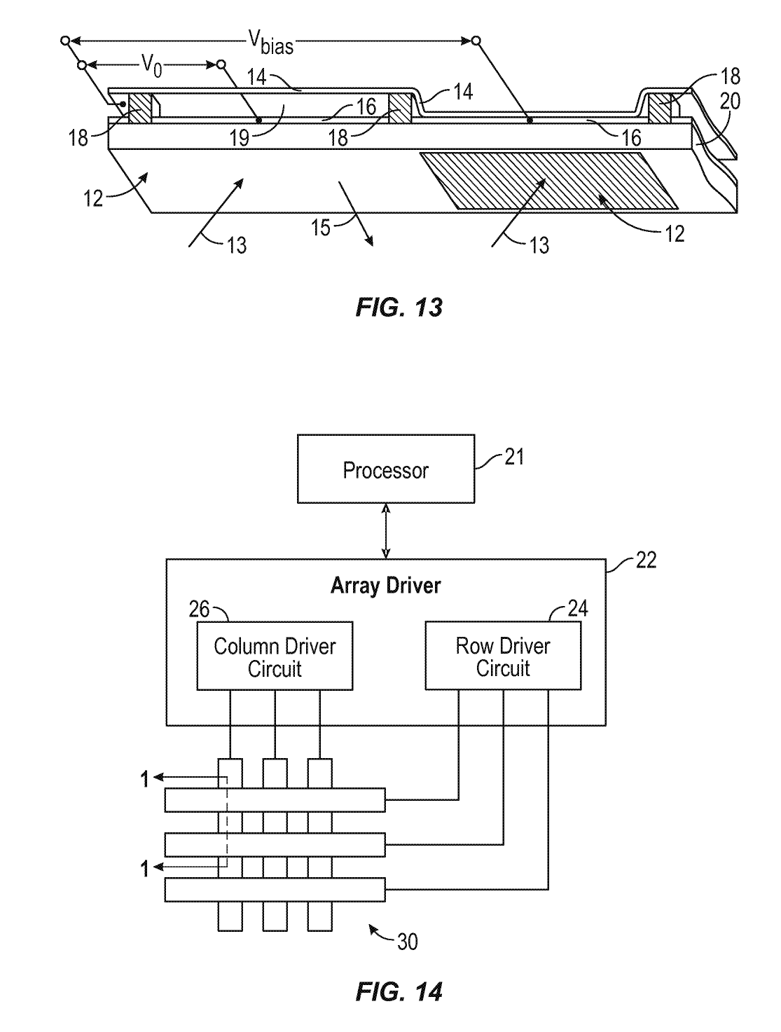

As described above, one example of a suitable display device to which the described implementations may apply, is a reflective display device such as an IMOD display device. FIG. 13 is an isometric view illustration depicting two adjacent IMOD display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 13 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 13, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 13 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (A).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 13, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 13. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 14 is a system block diagram illustrating an electronic device incorporating an IMOD-based display including a three-element by three-element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 13 is shown by the lines 1-1 in FIG. 14. Although FIG. 14 illustrates a 3×3 array of IMOD display elements for the sake of clarity, the display array 30 may contain a very large number of IMOD display elements, and may have a different number of IMOD display elements in rows than in columns, and vice versa.

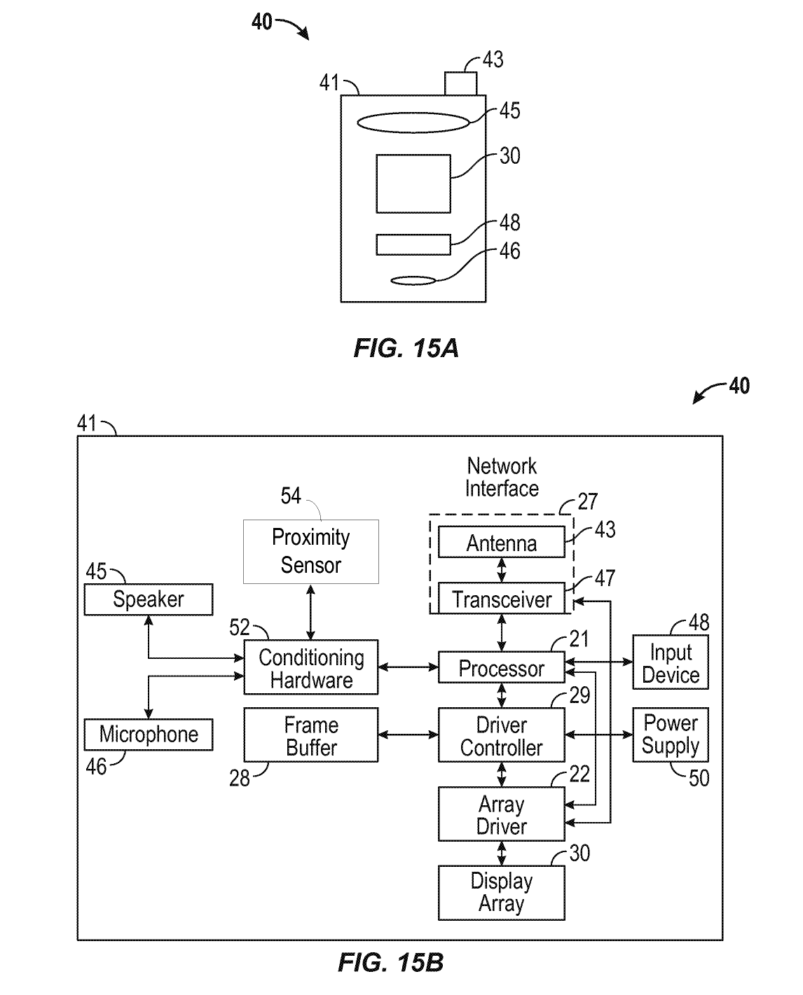

FIGS. 15A and 15B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 15A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The conditioning hardware 52 also may be connected to a proximity sensor 54. The proximity sensor 54 may be configured to provide input to the processor 21 of the display device 40 via the conditioning hardware 52. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 15A, can be configured to function as a memory device and be configured to communicate with the processor 21. In some implementations, a power supply 50 can provide power to substantially all components in the particular display device 40 design.

The network interface 27 includes one or more antennas 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display device comprising:
a transparent substrate through which an image can be displayed, wherein the transparent substrate includes a surface having a display region and a non-display region that surrounds at least a portion of a perimeter of the display region;
a first antenna formed in the display region of the transparent substrate, wherein the first antenna is substantially transparent; and
a second antenna cooperatively coupled with the first antenna.

2. The display device of claim 1, wherein the first and the second antennas are spatially diverse.

3. The display device of claim 1, wherein the second antenna is formed on the same surface of the transparent substrate as the first antenna.

4. The display device of claim 3, wherein the second antenna is formed in the non-display region of the transparent substrate.

5. The display device of claim 4, wherein the first and the second antennas are part of an array of antennas, wherein each of the antennas has at least one of spatial diversity, frequency diversity, temporal diversity, and polarization diversity with the other antennas in the array.

6. The display device of claim 1, wherein the second antenna is substantially non-transparent.

7. The display device of claim 1, further including one or more electrically conductive traces formed on the first antenna, the electrically conductive traces configured to electrically reinforce the first antenna.

8. The display device of claim 1, wherein the first and second antennas can each include at least one of a patch antenna, a dipole antenna, a planar inverted-F antenna, a slot antenna, a planar antenna, a meander-line antenna, a fractal antenna, a multi-band antenna, an ultra-wide band antenna, a circularly polarized antenna, a duplex antenna, a cancellation antenna, a beam-forming antenna, a steerable antenna, and an adaptive antenna.

9. The display device of claim 1, wherein the first and the second antennas have different operating frequencies.

10. The display device of claim 9, wherein the different operating frequencies include any one of a global positioning system (GPS), a Bluetooth protocol, a wireless local area network (WLAN), a Wi-Fi network, a worldwide interoperability for microwave access (WiMax) network, a radio frequency identification (RFID) band, a near field communication (NFC) band, a high-definition television (HDTV) band, a frequency modulation (FM) band, a multiple-input multiple-output (MIMO) system, and an ultra-wide band (UWB).

11. The display device of claim 1, further comprising a printed circuit board in electrical communication with the first antenna, wherein the second antenna is physically connected to the printed circuit board.

12. The display device of claim 11, wherein the first antenna is configured for receiving wireless signals and the second antenna is configured for transmitting wireless signals.

13. The display device of claim 1, further comprising a radio-frequency (RF) switch, wherein the RF switch is configured to selectively switch between the first antenna and the second antenna.

14. The display device of claim 13, wherein the RF switch is configured to selectively switch to the first antenna when a received wireless signal from the first antenna has a better signal quality than a received wireless signal from the second antenna.

15. The display device of claim 1, further comprising a proximity sensor and an RF switch, wherein the proximity sensor and the RF switch are configured to selectively switch to the second antenna when the proximity sensor detects a head of a user, the head proximate to the surface of the transparent substrate.

16. The display device of claim 1, wherein the first antenna and the second antenna form part of a multiple-input multiple-output antenna (MIMO) configuration.

17. The display device of claim 1, wherein the first antenna includes a transparent conductive oxide.

18. The display device of claim 1, further comprising a display element, wherein the first antenna and the second antenna are positioned on opposite sides of the display element.

19. The display device of claim 18, further comprising:
a processor that is configured to communicate with the display element, the processor being configured to process image data; and
a memory device that is configured to communicate with the processor.

20. The display device of claim 19, further comprising:
a driver circuit configured to send at least one signal to the display element; and
a controller configured to send at least a portion of the image data to the driver circuit.

21. The display device of claim 19, further comprising:
an image source module configured to send the image data to the processor, wherein the image source module includes at least one of a receiver, transceiver, and transmitter; and
an input device configured to receive input data and to communicate the input data to the processor.

22. A display device comprising:
means for displaying an image;
means for receiving a wireless signal disposed on a surface of the displaying means, wherein the receiving means is substantially transparent; and
means for transmitting a wireless signal cooperatively coupled to the receiving means.

23. The display device of claim 22, further comprising a printed circuit board in electrical communication with the transmitting means, wherein the transmitting means is physically connected to the printed circuit board.

24. The display device of claim 22, further comprising means for switching, wherein the switching means is configured to selectively switch between the transmitting means and the receiving means.

25. A method of manufacturing a display device, the method comprising:
providing a transparent substrate through which an image can be displayed, wherein the transparent substrate includes a surface having a display region and a non-display region that surrounds at least a portion of a perimeter of the display region;
forming a first antenna in the display region of the transparent substrate, wherein the first antenna is substantially transparent; and
coupling cooperatively a second antenna with the first antenna.

26. The method of claim 25, further comprising:
providing a printed circuit board in electrical communication with the first antenna, wherein the second antenna is connected to the printed circuit board; and
providing a display element between the printed circuit board and the first transparent antenna.

27. The method of claim 25, wherein the first and the second antennas have at least one of spatial diversity, temporal diversity, frequency diversity, and polarization diversity with each other.

28. The method of claim 25, wherein the second antenna is substantially non-transparent.

29. A method of operating a display device, comprising:
detecting a head of a user;
switching from a display-side antenna disposed on an exterior surface of the display device to an enclosure antenna disposed on an interior surface of the display device when the detected head is proximate the display-side antenna; and
transmitting a wireless signal from the enclosure antenna.

30. The method of claim 29, further comprising:
switching from the enclosure antenna to the display-side antenna when the head is not proximate the display-side antenna.

31. The method of claim 29, wherein detecting the head of the user includes detecting with a proximity sensor.

32. The method of claim 29, wherein the exterior surface includes a display region and a non-display region that surrounds at least a portion of a perimeter of the display region, wherein the display-side antenna includes one or more transparent antennas in the display region.

33. The method of claim 29, wherein the exterior surface includes a display region and a non-display region that surrounds a perimeter of the display region, wherein the display-side antenna includes one or more non-transparent antennas in the non-display region.

34. A machine-readable, non-transitory storage medium comprising computer executable instructions for operating a display device, the instructions comprising:
detecting a head of a user;
switching from a display-side antenna disposed on an exterior surface of the display device to an enclosure antenna disposed on an interior surface of the display device when the detected head is proximate the display-side antenna; and
transmitting a wireless signal from the enclosure antenna.

35. The machine-readable, non-transitory storage medium of claim 34, further comprising:
turning on the display-side antenna when the head is not proximate the display-side antenna.

36. The machine-readable, non-transitory storage medium of claim 34, wherein the computer executable instructions are configured to control one or more processors, wherein the one or more processors are operatively coupled to a proximity sensor configured to detect the head of the user.
